(19) United States
(12) Patent Application Publication
(10) Pub. No.: US 2013/0080044 A1
(43) Pub. Date: Mar. 28, 2013

(54) Automatic Docking System

(71) Applicants: Maxwell Tyers, Rancho Cucamonga, CA (US); Bradley Tyers, Currambine Western (AU)

(72) Inventors: Maxwell Tyers, Rancho Cucamonga, CA (US); Bradley Tyers, Currambine Western (AU)

(21) Appl. No.: 13/590,901

(22) Filed: Aug. 21, 2012

Related U.S. Application Data
(63) Continuation-in-part of application No. 12/950,990, filed on Nov. 19, 2010.

(51) Int. Cl. B63H 21/21; G08G 3/02

(52) U.S. Cl. CPC B63H 21/21; G08G 3/02
USPC 701/301; 440/1

(57) ABSTRACT

An automatic docking or parking system, comprising a plurality of left side and right side distance sensing transducers to determine the distance in this application between the hull of a marine vessel and an external structure and transmit the information to a processor control unit to control the systems propulsion elements to automatically dock and maintain a vessel's predetermined distance from an external structure.

### CROSS-REFERENCE TO RELATED APPLICATIONS

This application is a continuation-in-part application and claims priority to and takes the benefit of U.S. patent application Ser. No. 12/950,990 filed on Nov. 19, 2010, the contents of which are hereby incorporated by reference.

### BACKGROUND OF THE INVENTION

1. Field of the Invention

The present invention relates to ship collision avoidance systems, and more particularly to an automatic docking system which comprises a plurality of sensors which detect the distance between a dock and a vessel, and wherein the distance information provides feedback to a plurality of data processors in order for a plurality of thrusters and a main drive on the vessel, to drive the vessel sideways, fore and aft toward the dock at an appropriate speed and then stop the vessel when the desired distance from the dock is reached and finally, maintain that distance.

2. Description of the Related Prior Art

Docking operations of large vessels is a precision operation which may cause damage to the vessel or the dock if not strictly carried out. Maintaining the final position of the vessel requires the aid of multiple ropes and buffers. Dangerous weather conditions such as wind, currents and darkness, normally increase the risk associated with the docking operation.

Previous docking systems have required additional aids to assist in measuring the effects of these variables in order to provide visual aids to assist a skilled operator to manually dock the ship. The docking operation normally requires a skilled pilot and many deck hands to assist with docking. Furthermore, the larger a vessel, the greater the risk that exists, resulting in the greater the need for the application of skill and extra deck hands. As such, there is no prior art reference which adequately solves all the inherent and sometimes extraordinary problems associated with docking a vessel.

U.S. Pat. No. 6,677,889, issued Jan. 13, 2004 to Van Rees et al, provides a suggested auto-docking system that can assist an operator in docking a ship. The docking system provides visual aids with a close in radar system and a secondary propulsion system that is under control of a docking processor.

U.S. Pat. No. 7,021,231, issued Apr. 4, 2006 to Smart, is for a system configured to auto pilot and dock automatically a vessel, the system comprising: one or more laser or ultrasonic distance detectors: at least one extendable arm, the arm including attachment elements located at a far end thereof; and a control system configured to activate the arm and attachment elements to link with a dockside. The invention provides a method and system for auto piloting and docking automatically a vessel.

U.S. Pat. No. 6,978,729, issued Dec. 27, 2005 to Bertetti et al, claims a control system for boats. A boat has installed therein a primary propulsion system to produce a thrust at least in the longitudinal direction, manual controls for controlling the primary propulsion system, a transverse propulsion system for producing a transverse thrust, and a joystick control for controlling the primary and transverse propulsion systems for navigation at slow speed or in docking maneuvers. An electronic control unit controls the propulsion systems and receives information on the instantaneous speed of the boat and on the instantaneous distance between the boat and an obstacle such as the coast, the bottom or floating or half-submerged bodies. The electronic unit is so arranged that when the boat is located at a distance from an obstacle less than a predetermined distance it controls the propulsion systems to reduce the speed of the boat to below a predetermined limit, disables the manual controls of the primary propulsion system and enables the joystick control.

U.S. Pat. No. 7,561,886, issued Jul. 14, 2009 to Gonring et al, indicates a method by which a position of a marine vessel can be determined relative to a stationary object, such as a dock. Two position sensors are attached to a marine vessel and a microprocessor, onboard the marine vessel, computes various distances and angular relationships between the position sensors on the marine vessel and stationary transponders attached to the fixed device, such as a dock. The various dimensions and angular relationships allow a complete determination regarding the location and attitude of a marine vessel relative to the dock. This information can then be used by a maneuvering program to cause the marine vessel to be berthed at a position proximate the dock.

U.S. Patent Application #20080289558, published Nov. 27, 2008 by Montgomery, describes a laser radar based profile scanner for locating a target zone on a profile of a vessel comprising an emitter adapted to progressively or instantaneously radiate towards the vessel; a receiver providing a signal indicative of radiation incident thereon; a controller or processor including stored instructions, for energizing the emitter and receiving the signal, and adapted to determine the vertical location of the target zone relative to scanner.

U.S. Patent Application #20080033603, published Feb. 7, 2008 by Gensler et al, claims a system for automatically bringing a motor vehicle into a target position, having a sensor system and an analyzing unit for determining the position of the motor vehicle relative to the target position as well as devices for planning a collision-free drive from the current position to the target position, and devices for implementing the planned drive, a first part of the sensor system is arranged at or in the motor vehicle, and a second part of the sensor system is arranged in a stationary manner in a defined position close to the target position. It is mentioned that the invention may be used for the automatic docking of a ship can be implemented a defined position and location with respect to a quay wall.

U.S. Pat. No. 6,707,414, issued Mar. 16, 2004 to Van Rees et al, concerns a docking information system disposed on a ship which provides navigational information to the operator of the ship. The system includes a short range radar system and a display to provide a range between the ship and a dock or an obstacle and, optionally, a relative velocity between the ship and the dock or the obstacle.

U.S. Pat. No. 7,315,274, issued Jan. 1, 2008 to Fossum, puts forth a method for determining the relative position between two or more objects in a marine environment, including waterways, of which at least one object can be maneuvered relative to one or more other objects. At least one interrogator is arranged on one or more of the objects and sends a radio wave signal to at least one transponder arranged on one or more of the other objects. The novel method is the use of a FMCW radar in the interrogator, the use of the transponders for including identity tags into the signals to be reflected to the interrogator, and attitude determination. A system for this determination is also described.

U.S. Pat. No. 7,389,735, issued Jun. 24, 2008 to Kaji et al, discloses an apparatus for supporting docking of a marine vessel which includes a distance measuring unit that measures a distance between the marine vessel and a candidate docking site, a distance measurement controlling unit which controls the distance measuring unit to measure distances between the marine vessel and at least three measurement points defined around the candidate docking site, a configuration evaluating unit which evaluates the configuration of the candidate docking site based on the distances between the marine vessel and the at least three measurement points, and a docking suitability judging unit which judges, based on the result of the evaluation, whether or not the candidate docking site is suitable for docking of the marine vessel.

U.S. Pat. No. 6,995,662, issued Feb. 7, 2006 to Wortsmith, describes a vehicle positioning apparatus which is adaptable for the guidance of a vehicle into a limited space, such as in the case of a boat approaching a dock, slip, or trailer. The vehicle includes two emitters, producing two images reflected to the operator of the vehicle. The emitters are spaced from each other in such a manner that the operator may determine direction, orientation, and other critical parameters of the vehicle during approach to the limited space by viewing of the reflected images. Targets may be employed to enhance the image seen by the operator.

U.S. Pat. No. 5,274,378, issued Dec. 28, 1993 to O'Conner, is for a relative velocity indicator system for assistance in the docking of vessels uses a radar sensor providing a relative velocity signal indicative of the relative velocity between a ship and a reference, such as a dock. A wireless transmitter associated with the radar sensor receives said relative velocity signal and transmits a signal indicative of said relative velocity signal. A portable receiver and indicator unit carried by the captain of the vessel has a receiver for receiving the transmitted signal and an indicator arranged to receive, from said receiver, a receiver signal indicative of the transmitted signal and, thereby, of the relative velocity signal for indicating the relative velocity between ship and reference.

U.S. Pat. No. 5,432,515, issued Jul. 11, 1995 to O'Conner, provides a docking information system for assistance in the docking of vessels which uses sensors providing information indicative of the relationship between a ship and a reference, such as a dock, a coast line, a river bank, docks, bends and docking areas. A computer coordinates the information. A wireless transmitter associated with the computer transmits signals indicative of the information. A portable receiver and indicator carried by the captain of the vessel has a receiver for receiving the transmitted signals and an indicator screen to display the information. The remote receivers also include fixed monitors on the ship and on shore, and telephones on the ship which communicate with the computer and into the telephone link with shore-based communications.

U.S. Pat. No. 3,690,767, issued Sep. 12, 1972 to Missio et al, illustrates a docking system for large ocean-going vessels, which comprises a laser pulse range radar system having a laser transmitter and receiver, a retroreflector, and receiving and transmitting optics. Two such systems are disposed on a dock. The retroreflectors are disposed on the bow and stern of a vessel. The laser systems share a time interval meter, a computer, and a display panel. The lasers track the retroreflectors as the ship approaches the dock, and the time interval between the transmitted and received pulses is measured. Computations are made and the velocity of the approaching vessel, its distance from the dock, and the vessel position with reference to the dock are continually displayed. This information is then transmitted to the ship's captain.

Two U.S. Pat. No. 6,064,330 issued May 16, 2000 and U.S. Pat. No. 5,781,147 issued Jul. 14, 1998 to Elliott et al, show a fog piercing apparatus and method for accurately determining a target distance in adverse weather conditions utilizing both LASER and RADAR. The radar signals are used to determine an approximate range which is then used as a gating window for the determination of which laser reflection is from the actual target as opposed to a reflection from the atmospheric interference. The method basically comprises the steps of initiating a radar pulse in the direction of a target and receiving a reflection, transmitting a laser signal and receiving a plurality of reflections, determining an approximate range based on the radar signals, and using this approximate range to ascertain which of the laser reflections is from the target. This determination is preferably made by generating a gating signal and gate width from the radar signals and passing the set of laser range signals through the gate to eliminate the false signals and select the signal that survives the gate as the accurate target range.

U.S. Pat. No. 4,510,496, issued Apr. 9, 1985 to Ross, claims a docking system for positioning a vehicle relative to a selective location which employs a baseband communication link between the vehicle and the selected location. Transmitters located at specific points at the selective location are activated upon command from the docking vehicle and synchronized with reference signals radiated therefrom. Time delays between the arrival of each signal radiated by the transmitter and the initiation of a reference signal are determined to establish measures to the different points at the selected location. These measures are then processed to provide relative positioning information.

U.S. Pat. No. 4,216,538, issued Aug. 5, 1980 to Tomlinson et al, describes a navigation aid for determining berthing data which comprises distance detecting units embodying sonar transducers which are spaced apart along the length of a jetty a short distance behind the berthing line. The units are operative to provide signals indicative of the distance from the berthing line of correspondingly spaced sections of the ship, and a microcomputer selects two out of three of these signals and processes them to determine the distance from the berthing line of nominal bow and stern sections of the ship, the nominal measuring points being different from the actual measuring points at which the transducers are positioned. The microcomputer also processes the selected signals to determine the velocity of the bow and stern sections relative to the berthing line, and controls a jetty display of the determined distance and velocity data in addition to local and remote indications/recordal thereof.

U.S. Pat. No. 3,673,553, issued Jun. 27, 1972 to Miura et al, discloses a measuring instrument for piloting a ship for docking which is of the type that the parallel distance between the ship and a dock or pier and her approaching or leaving speed are measured on the side of the dock or pier and the measured results are reported to the ship to control her direction and speed so as to secure safety in the docking operation.

U.S. Pat. No. 3,754,247, issued Aug. 21, 1973 to Hansford, concerns a display apparatus which produces a display of a ship, a line representing an intended berth and indicators whose separation from the berth marker line represents the deviation of the closing rate of an associated part of the ship from a value determined by a function generator which generates an optimum function from signals representing the distance of the part of the ship from the berth. Radar is used to provide signals for operating the display

U.S. Pat. No. 3,772,693, issued Nov. 13, 1973 to Allard et al, illustrates a system for assisting the berthing of large ships measures their range and aspect relative to the berth and includes two master radars on the ship and two radar transponders at the berth and means for measuring the four ranges between each master radar and each transponder. Alternatively the master radars may be at the berth and the radar transponders on the ship.

U.S. Pat. No. 3,707,717, issued Dec. 26, 1972 to Frielinghaus, is for a system for generating correction command signals relative to the berthing velocity profile of a vehicle in approach of a docking position. A Doppler radar system including a radar transceiver projects signals between the docking position and the vehicle and responding generates Doppler shift frequency signals indicative of the velocity of the vehicle and the relative displacement thereof. A radar counter having preset initial counts stored therein indicative of anticipated initial berthing conditions, responds to the frequency shift signals by counting down from the initial counts in accordance with the Doppler shift. Means is included for updating the radar counter in accordance with actual conditions and includes a sonic detector which periodically projects sonic signals between the vehicle and the docking position and respondingly generates corrected count signals in accordance with the reflected sonic energy, indicative of actual distance of the vehicle to the docking position. Means is utilized which periodically transfers the corrected count signals to the radar counter, correcting for errors between actual and preset initial conditions. A velocity profile generator responds to the radar counter output and generates a programmed desired berthing velocity profile which a comparator responds to the velocity profile generator and the counter for generating command signals indicative of any discrepancy between the actual and desired vehicle berthing profile.

Therefore, the instant system and accompanying method of operation relate to a programmable system for automatically docking a vessel, once the system is engaged, wherein the system does not require any human intervention. Furthermore, the system possesses the ability to operate precisely in adverse conditions without the need or use for highly skilled pilots and/or extra deck hands, while simultaneously eliminating the risk of damage to the vessel or dock.

### SUMMARY OF THE INVENTION

The primary object of the present invention is to provide a Marine Vessel Automatic Docking (“MVAD”) system, which includes a programmable processor control unit (“PCU”) for automatically docking a vessel and eliminates the need for any human intervention upon engagement of the system and during docking operations. Moreover, the system is able to operate effectively in adverse weather conditions without the requirement for highly skilled pilots and/or extra deck hands. Additionally, the MVAD system removes the risk of damage to the vessel and/or the dock, due to the fact that the system enables the vessel to automatically move sideways towards a dock and then stops to maintain a predetermined distance from the dock thereby eliminating the possibility of any damage.

Another object of the present invention is the ability of the system to automatically position a vessel into a slip location regardless of normal wind and water currents.

Another object of the present invention is to maintain the final position of the water vessel without the aid of multiple ropes and buffers indefinitely while the MVAD PCU system of the present invention is in operation.

A further object of the present invention is to operate precisely in dangerous weather conditions such as wind, currents and darkness.

An additional object of the present invention is providing a self-operating control system for docking so that vessel handling skills or experience is not necessary.

One more object of the present invention is elimination of extra deck hands normally required to assist with docking.

Yet another object of the present invention is to provide a continual real time monitoring and controlling program to enable the water vessel to remain at a pre-selected distance alongside another stationary object, including a dock.

Still another object of the present invention is providing a universal monitoring and control system to enable efficient operation regardless of the length of the water vessel.

In brief, the Marine Vessel Automated Docking System (MVAD-PCU) of the present invention, once engaged is completely automatic, controlling precise location of marine vessel in relation to dock or object, thus completely overcoming all prevailing elements such as wind or currents with no human operator involvement required at all.

A completely automatic docking system of integrated interactive proximity sensing feedback and automatic control of water vessel positioning for a marine vessel requires no operator after setting the system in operation.

In one embodiment, the automatic docking system is controlled from a digital touch control panel which displays various functions. The operation of the automatic docking system is initiated by selecting the required function on the control panel. Furthermore, the automatic docking system allows for the final position of the marine vessel in relation to the position of the external structure by adjusting the distance through selecting the plus or minus switch on the control panel to achieve the desired number of feet, (i.e. two feet to forty feet).

Additionally, in one embodiment, the control panel is coupled to the MVAD PCU and relays the selected functions to the MVAD PCU, which subsequently initiates the functions to meet the various selections made on the control panel. In yet another embodiment, the MVAD PCU possesses a minimum default setting of two feet side clearance after each use.

In one embodiment, the operation of the automatic docking system may occur as follows:
1) Approach the dock and select the “ON” switch on the control panel;
2) Select the desired clearance between the parked vessels hull side and the dock by selecting the plus switch or minus switch on the control panel;
3) Stop the marine vessel fifty feet or less from the dock or external structure in a parallel orientation to the dock or external structure;
4) Select a port switch or starboard switch on the control panel and the MVAD-PCU will commence operation and engage the drive systems as required;
5) The marine vessel will automatically move sideways to the dock or external structure at a programmed closing rate speed of one foot every two seconds towards the dock regardless of normal wind or ocean currents; and
6) When the marine vessel hull is approximately ten feet from the pre-set distance from the dock, the control panel's programmed setting closing rate of speed diminishes to zero, stopping the vessel and allowing the vessel to remain at the distance from the dock that was programmed by the control panel while the system is engaged.

In one embodiment, if either the fore side or aft side distance sensing transducers do not detect a dock or external structure within sixty feet adjacent to the marine vessel hull, the MVAD PCU is programmed not to initiate operation.

If the marine vessel is secured to the dock the “OFF” switch may be selected on the control panel and the automatic docking system ceases to operate.

An advantage of the present invention is that no operator skill is required to carry out the docking operation.

Another advantage of the present invention is that is saves time in docking operations.

One more advantage of the present invention is that it saves labor during the docking process.

An additional advantage of the present invention is that it prevents damage to the dock.

A further advantage of the present invention is that it prevents damage to the water vessel.

There has thus been outlined, rather broadly, one of the more important features of an automatic docking system in order that the detailed description thereof that follows may be better understood, and in order that the present contribution to the art may be better appreciated. There are additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways, including applications involving other forms of moving vehicles. Also, it is to be understood that the phraseology and terminology employed herein are for the purpose of description and should not be regarded as limiting.

These together with other objects of the invention, along with the various features of novelty, which characterize the invention, are pointed out with particularity in the claims annexed to and forming a part of this disclosure. For a better understanding of the invention, its operating advantages and the specific objects attained by its uses, reference should be made to the accompanying drawings and descriptive matter in which there are illustrated preferred embodiments of the invention.

### BRIEF DESCRIPTION OF THE SEVERAL VIEWS OF THE DRAWINGS

These and other details of my invention will be described in connection with the accompanying drawings, which are furnished only by way of illustration and not in limitation of the invention, and in which drawings:

FIG. 1 is a diagrammatic perspective view of a Marine Vessel Automatic Docking “MVAD” system of the present invention displaying a plurality of distance sensing transducers for both port and starboard locations on a vessel, along with a programmable control panel disposed to initiate a variety of automatic functions and a MVAD processor unit designed to execute the selected automatic functions.

FIGS. 2-4 are diagrammatic perspective views of the MVAD system displaying the operation of various functions initiated by the programmable control panel and executed by the MVAD processor unit.

### DETAILED DESCRIPTION OF THE PREFERRED EMBODIMENTS

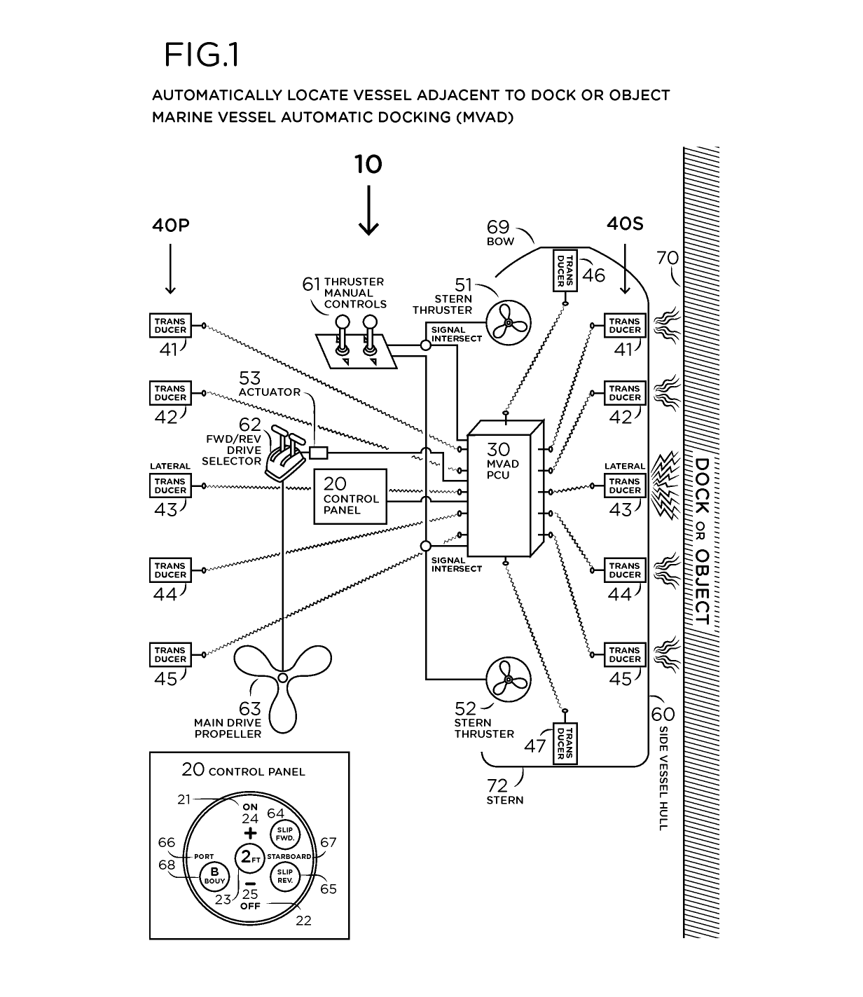

FIG. 1 illustrates a completely automatic docking system (10) of integrated interactive proximity sensing feedback and automatic control of water vessel positioning for a marine vessel which requires no human operator after setting the system in operation. The automatic system (10) comprises at least two means (40P) (port) and (40S) (starboard) for sensing distance between at least five spaced locations on each side of a hull (60) of a marine vessel and an external structure (70), such as a dock or another vessel that the marine vessel is approaching for the purpose of docking the marine vessel adjacent to the external structure, another vessel or dock. (70)

The means for determining distance comprises a plurality of distance sensing transducers, preferably including a pair of fore side transducers (41) and (42) for sensing distance between the fore position on the side of the hull (60) and the external object (70), and a pair of aft transducers (44) and (45) for sensing distance between an aft position on the side of the hull (60) and the external object (70), and a side transducer (43) for establishing a lateral position on the side of the hull (60) and the external object (70). While any means for sensing distance may be utilized, examples of usable means for sensing distance may include short distance radar up to one hundred feet (FIGS. 1-4 illustrate a starboard side of a vessel for illustrative purposes only).

The means for propelling the vessel comprises a bow thruster (51) and a stern thruster (52) for moving the hull side (60) of the marine vessel sideways into alignment with the external structure (70) and maintaining the side of the hull (60) of the marine vessel a set distance from the external structure (70). Furthermore, in one embodiment, a bow thruster (51), a stern thruster (52) and drive propeller (63) may all be used in the docking process.

Additionally, the MVAD PCU (30) comprises an automatic processor operating in real time to communicate between each of the transducers (41-45) and each of the propulsion elements (51, and 63) independently. The port bank of distance sensing means (40P) is used to bring the port side of the vessel (60) up to the external structure (70) and the starboard bank of distance sensing means (40S) is used to bring the starboard side of the vessel (60) up to the external structure (70).

In one embodiment, the fore side transducers (41) and (42) send a wireless transmission with real-time fore side distance measurements in relation to the external structure (70) to the MVAD PCU (30) which in turn controls the bow thruster (51) in response to the fore side to external structure (70) distance information.

In another embodiment, the aft side distance transducers (44) and (45) send a wireless transmission with real time aft side to external structure (70) distance measurements to the MVAD PCU (30) which in turn controls the stern thruster (52) in response to the aft side to external structure 70 distance information

The lateral distance transducer (43), located approximately midship, is disposed to record wireless transmissions with real time vessel to external structure (70) lateral location information to the MVAD PCU (30) which controls a plurality of actuators (53) which engage a forward/reverse drive (62) to operate the main drive (63) maintaining the recorded lateral position of vessel hull (60) relative to the dock (70).

In yet another embodiment, the MVAD PCU (30) automatically controls the propulsion elements to position the side of the hull (60) of the marine vessel adjacent to the external structure (70) at a preset distance from the external structure and to maintain the side of the hull (60) of the marine vessel at the set distance automatically with no human intervention required, thereby providing a completely automatic docking system of integrated interactive proximity obtaining feedback and automatic control of water vessel positioning for a marine vessel which requires no human operator after setting the system in operation.

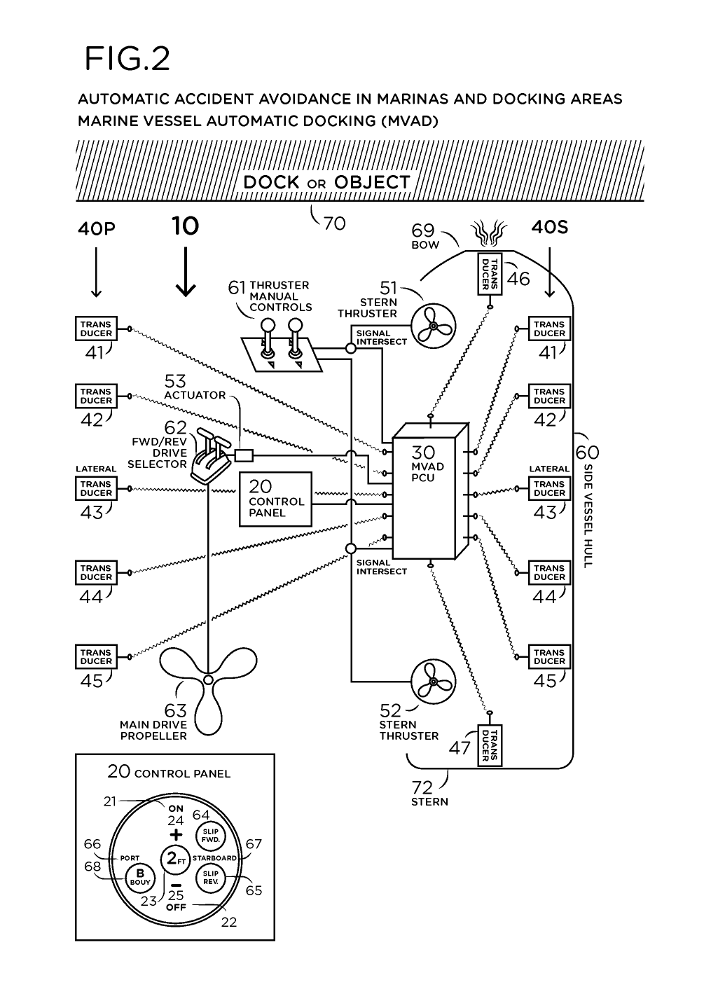

FIG. 2 illustrates an automatic collision avoidance function through the MVAD system, wherein if the forward drive (62) is operating and an “ON” switch (21) is selected on a control panel (20), then a bow transducer (46) is activated, and thereby transmitting information to the MVAD PCU (30). In this embodiment, the MVAD PCU (30) engages the actuators 53 which control the drive system (62) maintaining the vessel's speed preferably at a maximum of five knots. Alternatively, if an object or external structure (70) is detected by the bow transducer (46) at a distance of fifty feet or less, then the information is transmitted to the MVAD PCU (30). Subsequently, the MVAD PCU (30) will engage the actuators (53) to control the drive selector (62) and stop the vessel three feet from the external structure (70) automatically avoiding a collision and maintaining that position until an “OFF” (22) switch is selected on the control panel (20).

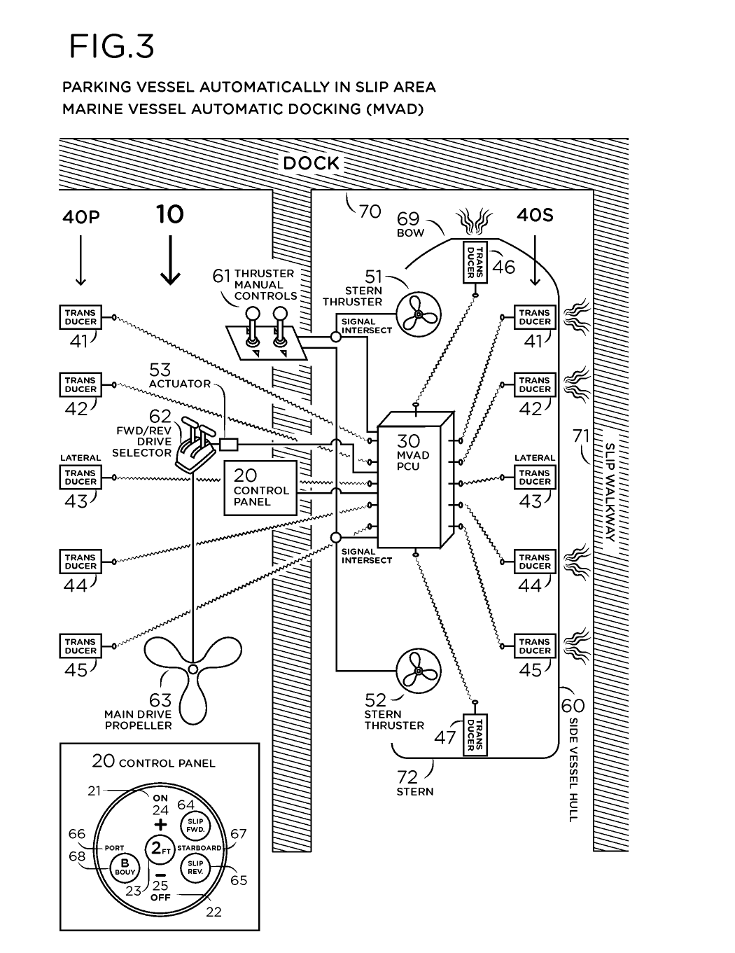

FIG. 3 illustrates an automatic slip operation function of the MVAD system. Initially, a slip location for a vessel may be described as follows: A dock is a secured flat mass bordering water which has no lateral movement and is generally one to six feet above the waterline. A slip walkway is attached to the dock at approximately ninety degrees to the dock extending out just above the water at a distance necessary to accommodate marine vessels of various lengths. There are usually two walkways (71) attached to the dock (70), one on each side of the vessel and this structure provides a safe U-shaped location for a marine vessel to be stored with the aid of ropes.

The MVAD slip feature operates in both forward or reverse, port (left side) or starboard (right side); whenever a slip forward (64) or slip reverse (65) is selected on the control panel (20), the MVAD PCU (30) maintains a vessels speed at approximately two knots and defaults to a 2 feet side clearance between side of vessel (60) and slip walkway (71).

In one embodiment, as a vessel enters the slip area, an operator of the MVAD system selects the slip forward (64) on the control panel (20). Thereafter, as soon as a port (66) or starboard (67) function is selected by an operator, the MVAD PCU (30) activates all components to execute the desired input from the control panel (20). As a vessel enters a slip, the fore side transducers (41) and (42), and aft transducers (44) and (45), transmit information to the MVAD PCU 30 along with the bow transducer (46). A distance of approximately two feet between the hull side (60) and slip walkway (71) will be maintained by the fore side transducers (41) and (42), and aft transducers (44) and (45), transmitting information to the MVAD PCU (30) which controls a bow thruster (51) and a stern thruster (52) and the actuators (53) controlling the drive system (62). The vessel will proceed to the dock (70) until the bow transducer (46) transmits a minimum distance of three feet between the dock (70) and the bow (69) of the vessel to the MVAD PCU (30), which will engage the actuators (53) controlling the drive system (62) which will stop vessel preferably three feet from the dock (70) and maintain this position resulting in a completely automatic operation until the “OFF” switch (22) is selected on the MVAD control panel (20).

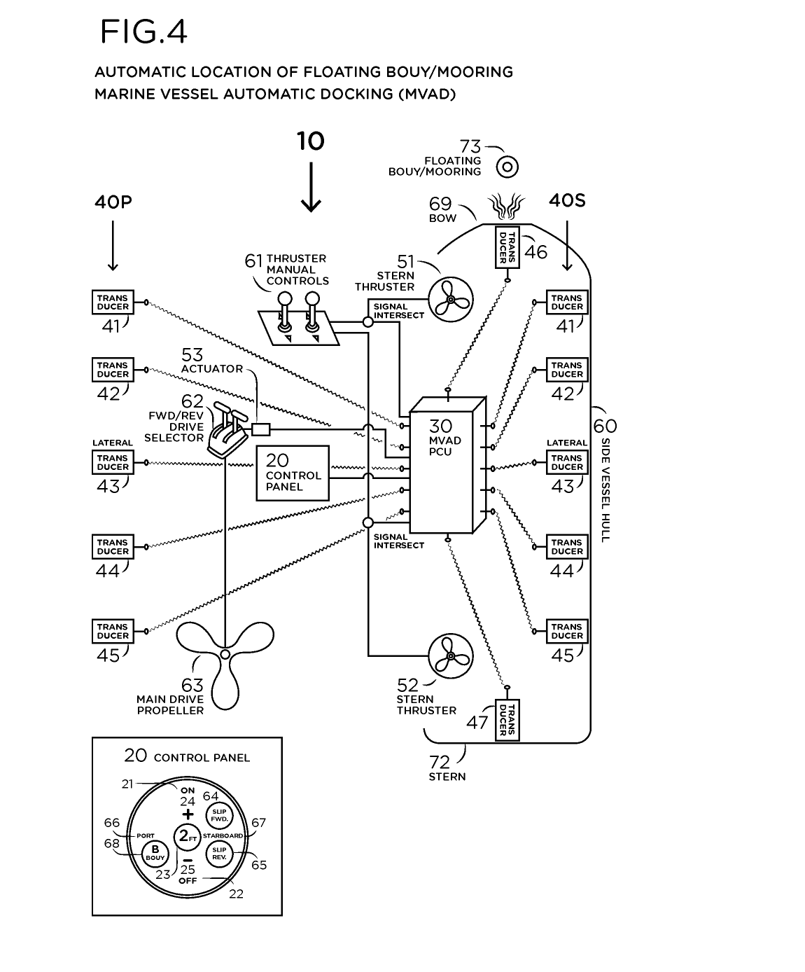

FIG. 4 illustrates a floating buoy/mooring operation of the MVAD system, wherein the operating process comprises at least one bow transducer (46) for sensing location and distance of a floating buoy/mooring (73). In this embodiment, the vessel bow (69) preferably may be brought into approximate alignment with the buoy/mooring (73) up to one hundred feet or less ahead of vessels bow (69). Upon approximate achievement of this preferred position, a buoy/mooring “B” (68) is selected on control panel (20). Thereafter, the MVAD PCU (30) in responding to information received from control panel (20), activates the bow transducer (46) which transmits distance, location and velocity information back to the MVAD PCU (30) which in turn controls the drive system (62) at a maximum speed of approximately two knots and controls a front thruster (51) to maintain direction of bow (69) to the floating buoy/mooring (73). Thus, when the bow of vessel (69) is approximately three feet from the buoy/mooring (73), the MVAD PCU (30) will activate a plurality of actuators (53) which control the drive systems (62) to stop the vessel and continue to control the drive system (62) and bow thruster (51) to maintain position of approximately three feet from the buoy/mooring (73) until the “OFF” switch (22) is selected on control panel (20).

In yet another embodiment, by activating the plus (24) or minus (25) on the digital control panel (20) comprises the means for inputting distance settings which are displayed (23), and by selecting + or − for the desired side distance between vessel hull (60) and dock or external structure (70) transmitting selected information to the MVAD PCU.(30) The system can be engaged by selecting “On” (21) on the digital control (20) and disengaged by selecting “Off” (22) on the digital control panel (20).

It is understood that the preceding description is given merely by way of illustration and not in limitation of the invention and that various modifications may be made thereto without departing from the spirit of the invention as claimed.

1. An automatic docking system for a marine vessel comprising:
a plurality of port distance sensing transducers, wherein each port distance sensing transducer is disposed to determine the distance between a port side of a hull of a marine vessel and an external structure;
a plurality of starboard distance sensing transducers wherein each starboard distance sensing transducer is disposed to determine the distance between a starboard side of a hull of a marine vessel and an external structure;
a processor control unit, wherein the processor control unit further comprises an automated processor in electronic communication with the port and starboard distance sensing transducers;
a plurality of propulsion elements, wherein the propulsion elements are in electronic communication with the processor control unit; and
a control panel, wherein the control panel is coupled with the processor control unit to initiate the programmable functions of the system.

2. The automatic docking system of claim 1, wherein the plurality of port distance sensing transducers comprise:
a fore side transducer, wherein the fore side transducer is disposed to sense the distance between the fore side position of a hull and the external structure;
an aft side transducer, wherein the aft side transducer is disposed to sense the distance between the aft side position of a hull and the external structure; and
a side transducer, wherein the side transducer is disposed to sense the distance between a lateral position of a hull and the external structure.

3. The automatic docking system of claim 1, wherein the plurality of starboard distance sensing transducers comprise:
a fore side transducer, wherein the fore side transducer is disposed to sense the distance between the fore side position of a hull and the external structure;
an aft side transducer, wherein the aft side transducer is disposed to sense the distance between the aft side position of a hull and the external structure; and
a side transducer, wherein the side transducer is disposed to sense the distance between a lateral position of a hull and the external structure.

4. The automatic docking system of claim 1 wherein the processor control unit comprises an automatic processor operating in real time to receive feedback from the plurality of port and starboard distance sensing transducers to allow for the activation of the plurality of propulsion elements in order to position and maintain the marine vessel at a predetermined distance from the external structure.

5. The automatic docking system of claim 1, wherein the processor control unit possesses a plurality of programmed defaults selected from the group consisting of: collision avoidance, slip operation, and floating buoy/mooring operation.

6. The automatic docking system of claim 5, wherein the processor control unit is coupled to a plurality of thruster controls providing the ability for the processor control unit to automatically operate the thrusters to achieve the programmed functions selected on the control panel.

7. The automatic docking system of claim 6, wherein the plurality of thrusters is coupled to a main drive of the marine vessel in combination with a plurality of actuators and is controlled by the processor control unit to execute the programmed functions selected on the control panel.

8. The automatic docking system of claim 1 wherein the plurality of propulsion elements comprise:
a bow thruster disposed to move the bow of the marine vessel relative to the external structure upon receiving a plurality of control information from the processor control unit based on the bow distance transducer information; and
a stern thruster disposed to move the stern of the marine vessel relative to the external structure upon receiving control information from the processor control unit based on the stern distance transducer information;
wherein the bow and stern thrusters, along with the drive propeller are disposed to maintain the proximal side of the hull of the marine vessel adjacent to the external structure at a distance selected from the external structure initiated on the control panel.

9. The automatic docking system of claim 1 wherein the plurality of propulsion elements further comprises:
a main drive propeller, wherein the main drive propeller is disposed to move the marine vessel in a lateral direction in relation to the external structure via the processor control unit with a plurality of actuators controlling a forward/reverse drive for the main drive propeller based on the port and starboard distance sensing transducers.

10. The automatic docking system of claim 1, wherein the processor control unit is disposed to receive a plurality of operations from the control panel selected from the group consisting of: supplying power to the processor control unit by selecting an on switch, disconnecting power to the processor control unit by selecting an off switch, selecting a distance between the marine vessel and the external structure to reduce the plurality of propulsion elements, and selecting a direction in relation to the external structure for the marine vessel to engage in docking.

11. The automatic docking system of claim 1, wherein the processor control unit possesses a minimum default distance setting of two feet between the marine vessel side and the external structure.

12. The automatic docking system of claim 1, wherein the processor control unit is disposed to maintain a permanent controlled approach to the external structure regardless of wind and current conditions.

13. A method for an automatic collision avoidance for a vessel utilizing the automatic docking system of claim 1, comprising the steps of:
selecting an on switch located on a control panel of the automatic docking system;
automatically activating a bow transducer upon selecting the on switch;
transmitting a plurality of distance data to a processor control unit;
engaging a plurality of actuators which control a drive system when an external structure is detected by the bow transducer; and
stopping the vessel three fee from the external structure.

14. A method for an automatic slip operation of a vessel utilizing the automatic docking system of claim 1, comprising the steps of:
selecting a slip function on a control panel of the automatic docking system;
entering a slip area;
transmitting a set of distance information between a hull of the vessel and the slip area by a pair of fore side and aft side transducers to a processor control unit;
maintaining a distance of two feet between the hull side of the vessel and the slip area by the transducers;
proceeding to the dock until the bow transducer transmits a distance of three feet between the dock and the bow of the vessel; and
engaging the actuators controlling the drive system of the vessel to maintain the position of the vessel.
